(19) United States
(12) Patent Application Publication
(10) Pub. No.: US 2015/0007030 A1
(43) Pub. Date: Jan. 1, 2015

(54) SYSTEM AND METHOD FOR ASSOCIATING VIDEO FILES

(71) Applicants: Aviv Noy, Hadar Ham (IL); Pnina Noy, Hadar Ham (IL)

(72) Inventor: Aviv NOY, Hadar Ham (IL)

(73) Assignees: Pnina Noy; Aviv Noy

(21) Appl. No.: 13/932,015

(22) Filed: Jul. 1, 2013

(51) Int. Cl. G06F 3/0484

(52) U.S. Cl. CPC G06F 3/04842
USPC 715/719

(57) ABSTRACT

The subject matter discloses a method for obtaining a video tree, said video tree comprises two or more video files to be displayed on an online web page, one video file of said video tree is a video root; receiving an uploaded video file at the online web page; receiving a video tree selection from the user that uploaded the video file, said video tree selection comprises the location of the uploaded video file in the video root; adding the uploaded video file to the video root according to the received video tree selection; displaying the video root with the uploaded video file on the online web page according to the video tree selection.

### FIELD OF THE INVENTION

The subject matter relates generally to associating video files.

### BACKGROUND OF THE INVENTION

Various video upload websites, such as YouTube, allow viewers to watch videos and to make a playlist of videos a viewer wishes to watch consecutively. Additionally, such video upload websites allow a person uploading a video to the websites to insert links to other videos that other viewers may be interested in.

Some video upload websites may be embedded in web pages of other web sites, such as Facebook. In such a case, a user can watch a video stored at YouTube while browsing on another page.

Users that upload various video files to the internet are not able to associate the various video files for other users. That is, the person that uploaded the video file is not able to determine that after viewing a certain video file, the next video suggested to the viewer of the video is a specific video.

Websites such as blogs allow viewers of a blog to textually comment on articles, pictures, videos and the like on the blog. The viewers can additionally comment on one another's comments by creating strings of textual commentary. The blog may have multiple single comments or multiple strings of textual commentary. In the commentaries viewers may be permitted to post text, images, or link videos that are hosted on a third party website, such as YouTube. Users are limited to respond to web content via text or links to videos hosted on another web page.

### SUMMARY

The subject matter discloses a method of associating videos on a tree-like structure, also referred to as a video tree. A video that is a successor on the video tree is uploaded by a user to respond to the predecessor video on the video tree. The method also provides that the videos of the video tree are displayed on a web page. The videos may be associated with an internet link, such as a URL address. In some cases, when a link of a target video is accessed, the viewer views the predecessors of the video before viewing the target video.

It is an object of the subject matter to disclose a method, including:

obtaining a video tree, the video tree comprises two or more video files to be displayed on an online web page, one video file of the video tree is a video root; receiving an uploaded video file at the online web page; receiving a video tree selection from the user that uploaded the video file, the video tree selection includes the location of the uploaded video file in the video root; adding the uploaded video file to the video root according to the received video tree selection; displaying the video root with the uploaded video file on the online web page according to the video tree selection.

In some cases the method includes a step of designating a time marker for displaying the uploaded video file, wherein the time marker is in the middle of another video on the video tree. In some cases the method includes a step of displaying the uploaded video file according to the designated time marker. In some cases the root video is the first video of the video tree. In some cases the uploaded video is linked to the root video.

In some cases the branch video is linked to a branch video of the root video. In some cases uploading the video file does not interfere with the order of display of other video files of the video tree.

In some cases the method includes updating the graphically displayed video tree upon displaying a new video of the video tree.

In some cases the method includes receiving a viewer's selection as to a next video of the video tree to be displayed after a current video of the video tree being displayed, wherein the next video is selected from a plurality of video files of the video tree connected to the current video.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1A shows a display device having a video display area and a video tree display area, according to some exemplary embodiments of the subject matter;

FIG. 1B shows a system for associating a video file to a video tree, according to some exemplary embodiments of the subject matter;

FIG. 2A shows a method of constructing a video tree, according to some exemplary embodiments of the subject matter;

FIG. 2B shows a method of displaying a video tree, according to some exemplary embodiments of the subject matter;

FIG. 3A shows a video tree, according to some exemplary embodiments of the subject matter;

FIG. 3B shows a video tree after a frame shift, according to some exemplary embodiments of the subject matter;

FIG. 4A shows a tree view of the video tree, according to some exemplary embodiments of the subject matter;

FIG. 4B shows a landscape view of the video tree, according to some exemplary embodiments of the subject matter;

FIG. 4C shows a portrait view of the video tree, according to some exemplary embodiments of the subject matter; and,

FIG. 5 shows a display of a video tree with a media player displaying a video, according to some exemplary embodiments of the subject matter.

### DETAILED DESCRIPTION

The subject matter discloses a system and a method for connecting video files that are uploaded by users of a web page as responses to other video files. The videos may be arranged as a video tree that includes video files. The video files in the tree are uploaded by users in order to respond to other videos in the video tree. The first video file of the video tree is defined as a root video, and may be uploaded by a content website, such as cnn.com. Then, users create and upload video files that function as branch videos on the video tree, the branch videos respond to other videos in the video tree. In many cases, in order to view a specific video on the video tree, also defined as a target video, a viewer is required to view all the videos that lead to the target video, from the root video via other predecessors of the target video. The user may reach the target video upon pressing a link. The videos leading to the target video are displayed consecutively to the viewer wishing to view the target video, for example on an internet web page. The order of the video files to be displayed consecutively prior to the target video may be determined by the user who uploaded the target video. The consecutive display of the movies prevents delay buffer between the successor videos in the video tree, by buffering successor videos at the user's device.

In some cases, the target video is also connected to successor videos which are uploaded by users as responses to the target video. After the target video is displayed to the viewer, the system of the subject matter may automatically determine additional videos to be displayed to the viewer, for example successor videos of the target video on the video tree. When the viewer does not select a target video, the system automatically selects a default path of videos in the video tree. The determination of additional videos may be performed according to various parameters, such as the number of views of a video, the most commonly linked video to the target video being viewed, viewer feedback, and the like. In some cases, the user may modify the path that leads to the target video by selecting another video as a new target video. Then, the system displays videos that lead from a currently displayed video to the new target video and ceases displaying predecessor videos that lead to the old target video. After the new target video is displayed, the system continues to display additional movies of the video tree to the viewer. The additional videos displayed after the new target video are successor videos of the new target video.

The subject matter further discloses a system for storing and regulating the video tree. The system receives videos to be added to the video tree from users, as well as the location of the uploaded video on the video tree, as desired by the user who uploads the video. The location of the uploaded video on the tree is selected by the user according to the identity of the video to which the user responds. The added video is a successor of the video to which it responds.

The system enables a user who uploads a video to the video tree to select a time marker of the predecessor video. The time marker defines a time in the predecessor video in which the successor video is displayed. For example, the user who uploads a new video may select that the added video is displayed exactly 2 minutes and 12 seconds after the beginning of the predecessor video. For example, the added video may be a response to a scene that ends 2:12 from the beginning of the predecessor video.

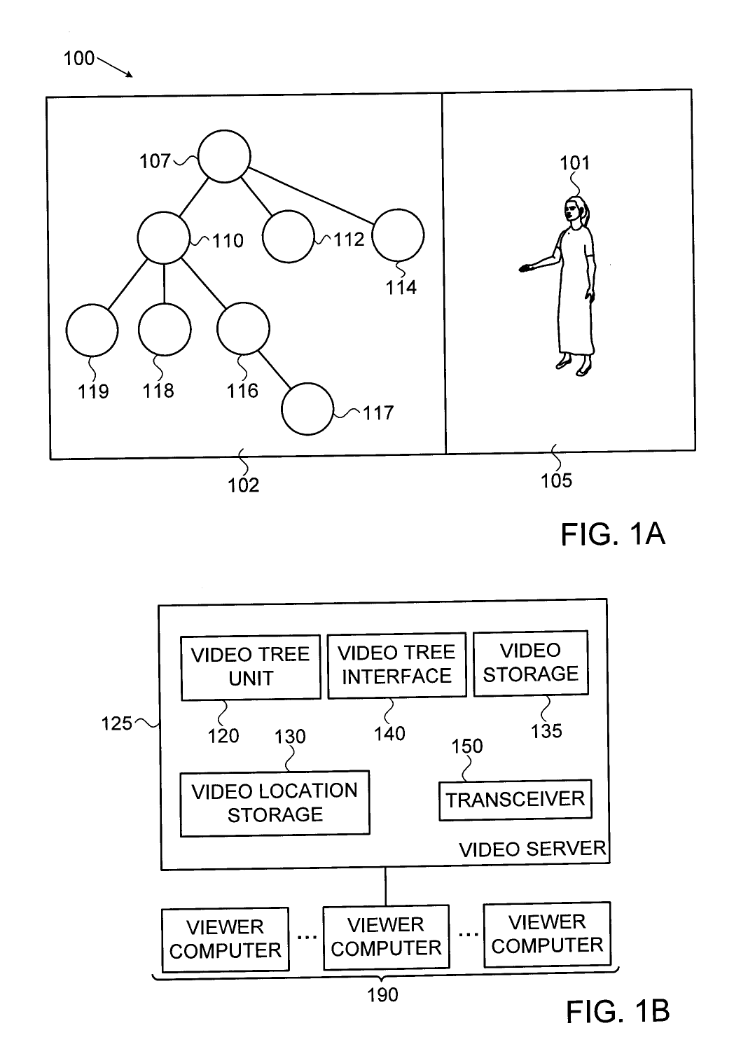

The system may also determine parameters related to the display of the entire video tree as shown in FIG. 1A. FIG. 1A shows a display device 100 having a video display area 105 and a video tree display area 102. A person 101 can be seen as part of the video displayed in the video display area 105. The video tree display area 102 shows the video tree including the video root 107, three successor videos 110, 112 and 114 of the video root 107, three successor videos 116, 118 and 119 of the video 110 and a successor video 117 of the video 116. In some exemplary cases, when a viewer wishes to view video 117, the system consecutively displays the root video 107, then the successor videos 110 and 116 and then the target video 117. The graphical display of the video tree may change after displaying a video of the video tree, for example change after displaying the video 116.

The system may display a video of the video tree as well as a graphical representation of at least a portion of the video tree. The displayed video may be the target video, a predecessor of the target video, or a successor of the target video. The graphical representation of the video tree may include the root video, the target video, the video currently displayed and the like. In some cases, the graphical representation of the video tree changes while various video files are displayed. For example, only a portion of the video tree is displayed, having the currently displayed video at the center of the graphical representation of the video tree. Then, when a new video is displayed, a new video is located at the center of the graphical representation. Updating the graphical representation may also be referred to as frame shift of the display of the video tree.

In some exemplary embodiments of the subject matter, the system may suggest additional videos of the video tree to the viewer while viewing a particular video of the video tree. The system may transmit links to the additional videos. The additional videos may be uploaded by the same user who uploaded the video the viewer is watching. The system may designate the additional videos according to the viewer's social network connections, such as friends on Facebook, or contacts in an e-mail list, and the like. In some cases, a viewer computer display of the video tree comprises icons for providing feedback about the videos comprising the video tree.

The viewer of a video file of the video tree may provide a video feedback to a specific video of the video tree. The video feedback may be “like”, “unlike”, feedback to another feedback and the like. The video feedback may comprise an icon, such as a heart, fire, boxing glove, light bulb, and the need to add more explanations about emotions that represent brief of the reopens contents. For example, a heart icon may display that the video is a favorite and that is very much liked, a flame icon may display that the video is hated, a boxing glove icon discloses that the video is a disliked comment to the previous video in the video tree, a light bulb may display that the video is a liked comment of the previous video in the video tree. The emotion icons inform future users of whether a particular video in the video tree is popular, disliked, recommended, or the like.

The video feedback may be displayed near the video when the video tree is visually displayed on the viewer computer. Displaying the video feedback enables viewers of the video tree to select videos they wish to view, as the video feedback implies or represents the emotion of the user towards the video he responded to.

In some cases, the video tree may be embedded into an internet website, where viewers observe the video tree, which may be the commentary for the content of the internet website. For example, a blog writer posts an article on the blog writer's blog. The blog writer adds a video content to the commentary section, which is the root video of the blogger's video tree. Viewers of the blog may then add branch videos to the blogger's video tree that respond to the root video and to other videos on the blogger's video tree. The blog may have many video trees, for example the blogger may found a new video tree for every new post on the blog. The video tree may begin displaying videos consecutively after a display of an image. Videos of the video tree may respond to the image. The videos of the video tree may also be displayed after an article on a content website, such as cnn.com. The video tree may be customized according to the requirements of the content website. For example, after an article or video on cnn.com, a link transfers the user to the video tree of the particular article or video. For example, the video regulating system detailed below may be embedded in a content website or communicate with a content website but on a separate server having the look and feel of the content website.

FIG. 1B shows a system for associating a video with a video tree, according to exemplary embodiments of the subject matter. A video regulating system 125 comprises a video storage 135, which stores uploaded videos uploaded by users of a web page. The users may be moderators of the video regulating system 125 or a viewer viewing videos using a viewer computer of multiple viewer computers 190 connected to the video regulating system 125. The viewer computer 190 may be a laptop, desktop, mobile device, cellular phone, tablet, PDA and the like. The video storage 135 may store the uploaded videos with additional information, for example, information regarding other videos linked to the uploaded video, a date on which the uploaded video was uploaded, a title of the uploaded video, a length of the uploaded video, and the like. The video storage 135 stores videos of the video tree and the connections there-between. The video tree comprises data as to the manner in which various videos are linked together.

The video regulating system 125 further comprises a video tree unit 120, which determines the order in which videos in the video tree are available to be viewed by the viewer that uses the viewer computer 190. The video tree unit 120 obtains the data of the video tree from the video storage 135. The order of videos to be displayed to the viewer is determined according to the location on the video tree of the target video selected by the viewer. The data of the video tree comprises data of the root video, which is the first video of the video tree displayed to the viewer computer 190. The branch videos may be linked to their predecessor videos at designated time markers throughout the duration of the predecessor videos. In other cases, the branch videos may be designated to be displayed once the predecessor video ends. The video regulating system 125 comprises a transceiver 150 that receives the root video to be transmitted to the viewer computer 190 from the video tree unit 120; the root video is to be displayed at the viewer computer 190.

In some exemplary embodiments of the subject matter, the video regulating system 125 may transmit video data to multiple viewer computers 190, wherein each viewer computer of the multiple viewer computers 190 is receives a different video tree or a different video stored on the video regulating system 125. In some exemplary embodiments of the subject matter, the transceiver 150 pings the video computer of the multiple viewer computers 190 to determine the rate at which the transceiver 150 may transmit a video from the video tree.

The viewer computer 190 may be used by a viewer of videos stored on the video regulating system 125. The user may wish to upload a desired video to the video regulating system 125 and link the uploaded video to a specific video of the video tree. The user using the viewer computer 190 may upload the desired video to the video regulating system 125 and create a new video tree or to link the uploaded video to a pre-existing video of the video tree. The viewer computer of the multiple viewer computers 190 transmits the video to be uploaded to the video regulating system 125. The transceiver 150 of the video regulating system 125 receives the video and transfers the video to a video location storage 130, which links the video to the video tree. In some cases, receipt and transmission of videos to and from the video regulating system 125 is performed using a communication network or a network panel, without a transceiver. The video regulating system 125 enables the user who uploads a video to determine the location of the uploaded video on the video tree. That is, to determine that the uploaded video is a response to another video and is only displayed after the other video, as the other video may be a root video or a branch video.

The video location storage 130 designates the uploaded video as a branch video or as a root video. The video location storage 130 designates the videos to which the uploaded video is linked. The video location storage 130 determines whether the uploaded video is already stored in the video storage 135and designates a message to be transmitted to the uploader that the uploaded video is already stored on the video regulating system 125. The video location storage 130 may also designate additional links between branch videos stored in the video storage 135, but are not predecessors of the uploaded video, for example in case the branch videos have tags similar to the tags of the uploaded video.

The video regulating system 125 further comprises a video tree interface 140. The video tree interface 140 provides an interface for the user that uploads the video file into the video regulating system 125, for connecting the uploaded video to another video file of the video tree. The video file to which the uploaded video is connected is considered a predecessor of the uploaded video. The video tree interface 140 enables the user that uploads the video file to select which video file of the video tree is with the predecessor of the uploaded video.

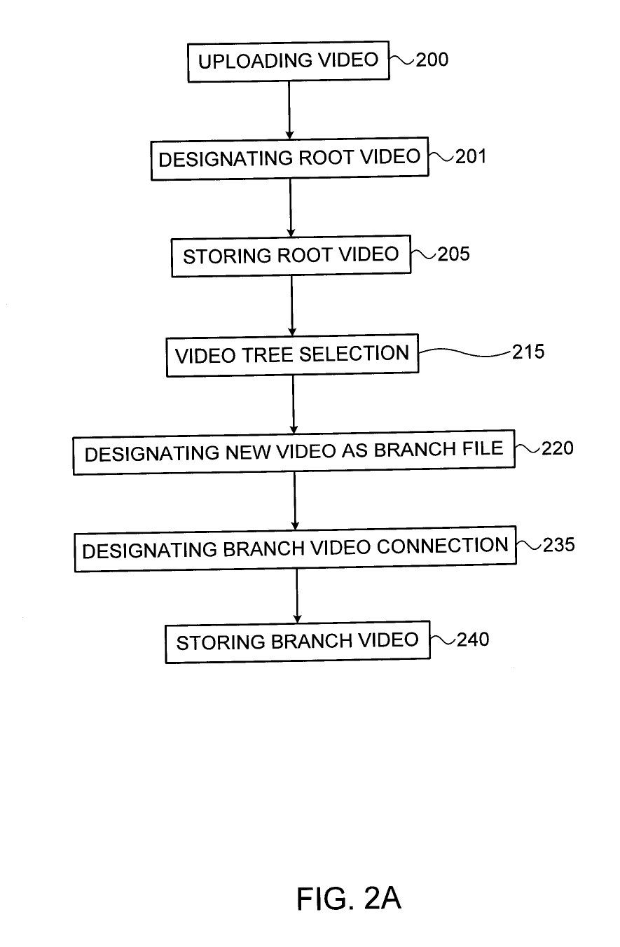

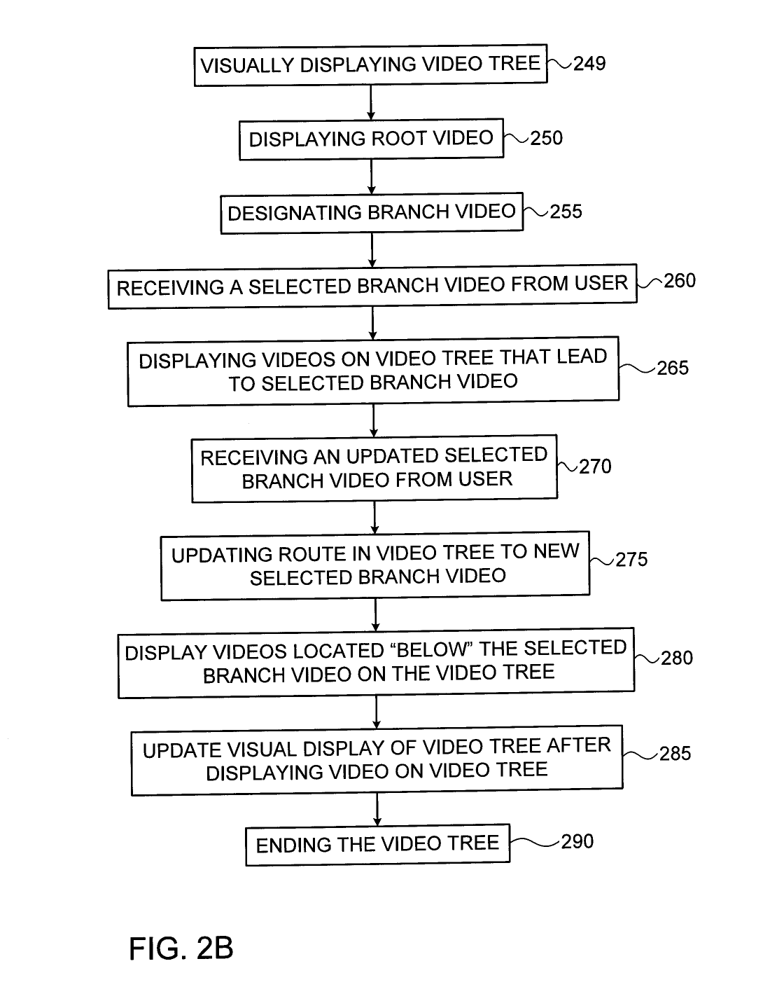

FIG. 2A shows a method of constructing a video tree, according to exemplary embodiments of the subject matter. Step 200 discloses receiving an uploaded video at the video regulating system 125 of FIG. 1B. The uploaded video may be a first video included in the video tree. In such case, the uploaded video will be the first video to be displayed when a viewer of the video tree. The first video is uploaded to the video regulating system 125 from the viewer computer of the multiple viewer computers 190, for example by the moderator of the video regulating system 125. The uploaded video is uploaded to the video regulating system 125 through the transceiver 150 of FIG. 1. The uploaded video may be a branch video to be connected to another video of the video tree. In some exemplary cases, the uploaded video received at the video regulating system may be generated using a video generation interface that resides on a webpage. The video generation interface receives a video stream from the computer of the user that uploads the video and transmits the video stream to the video regulating system 125.

Step 201 discloses designating the uploaded video as a root video. The uploaded video is stored at the video location storage 130 of FIG. 1, which designates the uploaded video as the root video, and creates the video tree which begins with the root video. The video tree may be titled using the name of the root video, for example, if the root video is titled “Man in the park,” the video tree will be given the same title, “Man in the Park”. Step 205 discloses storing the video. The video location storage 130 transfers the video tree comprising the root video to the video storage 135 to be stored.

The new video may be uploaded by the viewer of the root video or some other entity interacting with the video regulating system 125. The viewer of the root video uses a viewer's viewer computer to upload the new video to the video regulating system 125. The new video is received by the transceiver 150, which transfers the new video to the video location storage 130, where the location of the new video in the video tree is determined and stored, according to the predecessor video.

Step 215 discloses receiving a video tree selection from the user that uploaded the video file. The video tree selection comprises the location of the uploaded video file in the video tree as desired by the user that uploaded the video file. The location is selected by the user according to the video to which the user responds. For example, in case the video tree is a list of 5 videos, the user that uploaded the video file may choose that the uploaded video file is displayed after the third video file of the video tree. In such a case, the uploaded video file is only displayed after the root video and two additional predecessor videos of the video tree. The user that uploaded the video file does not change the order of display of other video files of the video tree. For example, according to the list of video files disclosed above, the video file that was fourth on the list will be displayed after the same three video files as before the new video was uploaded.

The video location storage 130 receives the video tree selection and connects the uploaded video file to the appropriate predecessor video file of the video tree. The uploaded video file is a response video to the predecessor video file.

In some exemplary cases, the video location storage 130 searches the video storage 135 to determine whether the uploaded video file has been previously uploaded to the video regulating system 125 and stored as part of the video tree. In some cases, the uploaded video file has been uploaded by a different viewer, and is already linked in the video tree. Then, the video regulating system 125 transmits a message to the computer of the user that uploaded the video to the video regulating system 125 and notifies the user that the new video is already part of the video tree.

In the cases where the new video was not previously stored in the video storage 135 as part of the video tree, the video location storage 130 performs step 220, which discloses designating the new video as a branch video. The video location storage 130 designates the new video to be part of the video tree. The new video may be designated to begin playing at a predefined time marker after the predecessor video. The designated time marker may be a function of the location of the uploaded video file in the video tree. In some exemplary embodiments of the subject matter, the user that uploaded the video file may add an additional branch video to another branch video. The video regulating system 125 designates the time marker in which the new video is displayed after the predecessor video. The video location storage 130 creates the time marker. In some cases the branch video is displayed after the predecessor video is complete, and the video location storage 130 creates the time marker at the end of the predecessor video.

Step 235 discloses designating the link of the uploaded video file on the video tree. The video location storage 130 receives the designation transmitted by the user that uploaded the video file. The video location storage 130 links the uploaded video to the designated location at the video tree. For example, the video regulating system 125 receives a designation from the user that uploaded the video file to connect the uploaded video as a branch video that is linked to the root video and displayed at the time marker 2 minutes and 13 seconds from the beginning of the root video. The video location storage 130 links the new uploaded video to the root video at the time marker located at 2 minutes and 13 seconds, which pauses the root video and begins displaying the new uploaded video linked at the designated time marker. In another example, the new uploaded video is designated to be linked to a specific branch video in the video tree. The user, who uploaded the video file, designates the time marker of 1 minute and 2 seconds from the beginning of the specific branch video in the video tree. The video location storage 130 links the branch video to the designated time marker of 1 minute and 2 seconds from the beginning of the some other branch video in the video tree.

Step 240 discloses storing the uploaded video file. After the video location storage 130 links the uploaded video file to the designated video file in the video tree, the video location storage 130 transfers the uploaded video file and linking information of the uploaded video file to the video storage 135. The video storage 135 stores the uploaded video file linking information and the uploaded video file as part of the video tree to which the uploaded video file was added.

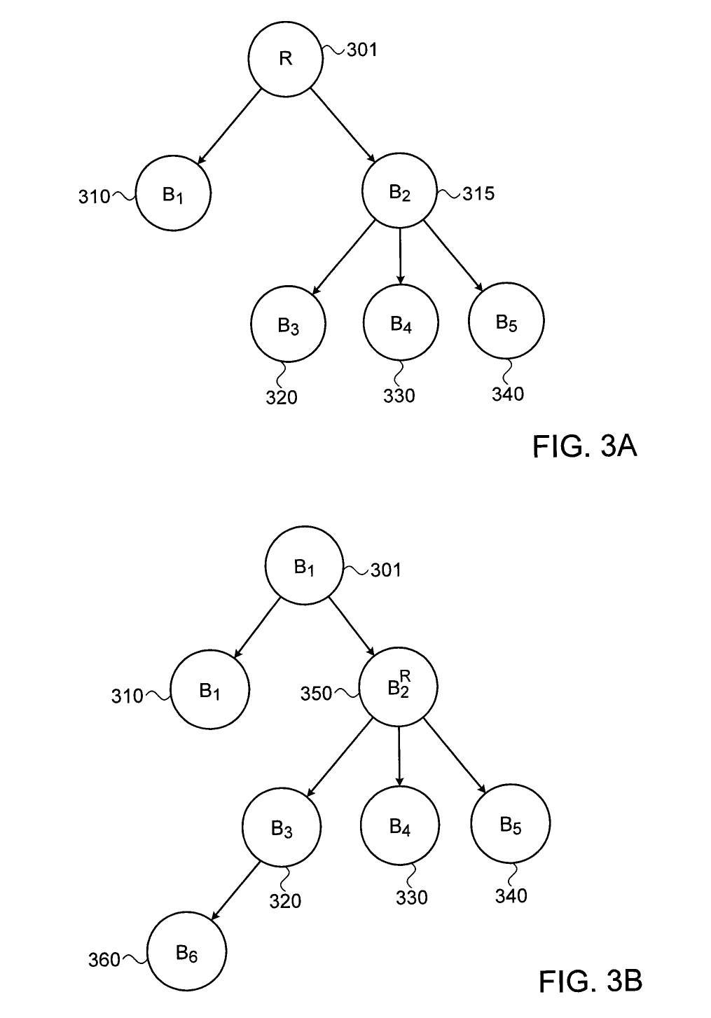

FIG. 2B shows a method of displaying a video tree, according to exemplary embodiments of the subject matter. Step 249 discloses visually displaying a video tree on the viewer computer 190 of FIG. 1, which allows a user to view the videos available for viewing in the video tree. The visually displayed video tree is also disclosed in FIGS. 3A and 3B of the subject matter. The visual display of the video tree comprises marking a route of videos in the video tree that are displayed prior to the target video selected by the user. The target video may be selected by the video regulation system, after the video selected by the user is displayed, as detailed below. The route to the target video comprises the predecessor videos of the target video and links between the predecessor videos. As such, when the user views a video on the video tree, he can also view the other videos remaining until the target video is displayed. The video tree is displayed to show the root video of the video tree as well as any video branches that may comprise the video tree. For example, the video tree comprises 4 branch videos that are linked to the root video; the display of the video tree will show the root video with 4 branch videos connected by lines to the root video. In some cases, the visually displayed branch videos have additional branch videos linked to the branch videos. In such cases, the additional branch videos are visually displayed as linked to respective branch videos with lines. In some exemplary embodiments, the video tree system links commercial content video branches to videos in the video tree. Such commercial content branch videos may be displayed with an identifying marker, for example an “X”, which distinguishes the commercial content video from the other branch videos in the video tree. In some cases, the video tree may comprise more than one commercial content branch video. In some cases the viewer computer 190 only displays a portion of the video tree, for example only 5 of the 30 videos of the video tree. In such cases the viewer may designate which portion of the video tree is viewed on the viewer computer 190.

In some cases, the video files of the video tree may be displayed according to the topic of each video of the video tree, and not according to the order of the videos in the video tree. The topic may be determined by the user that uploads the video file into the video tree. The topic may be selected from the predefined list of topics, such as news, economics, celebrities, sports and the like. The topic or an icon representing the topic may be displayed along with the video file on the video tree, when the video tree is graphically displayed.

The video tree may contain links to a webpage associated with the discussion of the video tree. For example, in case the videos of the video tree contain comments on a sports event, the video tree may contain a link to a webpage that contains an article on the specific sports event related to the discussion. The video tree may comprise an image associated with the topic of the discussion, for example an image of the sports event.

Step 250 discloses displaying the root video. The viewer transmits a request to the video regulating system 125 to view a specific video of the video tree. The viewer requests a specific video file of the video tree. Then, the video regulating system 125 transmits video files that are predecessors of the specific video file in addition to the specific video file itself.

The video regulating system 125 receives the request from the viewer computer. The request is transferred to the video tree unit 120, which obtains the desired videos of the video tree from the video storage 135. The video tree unit 120 obtains the root video of the video tree from the video storage 135, and transfers the root and additional videos of the video tree, as well as the requested video, to the viewer computer. In some exemplary embodiments of the subject matter, the transceiver 150 or another communication unit such as a LAN or WAN network, transmits the videos in the video tree in a streaming manner to the viewer computer. In some exemplary embodiments, the video tree unit 120 scans the video tree while the root video or some branch video is transmitted to the viewer computer to determine whether a new branch video has been added to the video tree.

Step 255 discloses designating a particular branch video of the video tree to be displayed. In some exemplary embodiments of the subject matter, the video tree transmitted to the viewer computer comprises branch videos that are stored to be displayed to the viewer at predetermined time markers of the predecessor video's duration. During the display of the predecessor video, the video tree unit 120 obtains the time marker of the successor video. In some exemplary embodiments of the subject matter, multiple successor videos may be designated to the same time marker. In such cases, the video tree unit 120 may be given prior instruction as to the display of a predecessor video of the target video selected by the viewer. In some cases, the order of display of videos is determined by parameters not related to the order of videos on the video tree. For example, displaying a branch video according to the number of previous views of the branch videos, or the viewer watching the video tree selects which branch video is to be displayed.

Step 260 discloses receiving a selected branch video from the user. The selected video branch may be video branch B3 320 of FIG. 3A below. The selected branch video may be connected to a web page of a content website. The selected branch video may be uploaded in response to another video of the video tree.

Step 265 discloses displaying videos on video tree that lead to selected branch video. For example, in case the selected branch video is video branch B3 320, the videos displayed to the user begin in the root video 301, then branch video 315 and then branch video 320, which designates the video selected by the user. In some exemplary cases, the video tree only enables one predecessor video to any branch video on the video tree.

Step 270 discloses receiving an updated selected video from the user. For example, in case the user first selected branch video 320, he may then select a new selected branch video, for example branch video 340 of FIG. 3A.

Step 275 discloses updating route in video tree to a new selected video. After receiving a new selected video, the system of the disclosed subject matter updates a list of video files to be displayed to the user, according to the location of video files on the video tree. The updated list of video files comprises predecessors of the selected branch video, according to the location of video files on the video tree.

Step 280 discloses display successor videos of the selected branch video on the video tree. After the selected branch video is displayed to the user, the system can automatically continue and display other videos in the video tree, for example successors of the selected video tree. Determination of the additional video files displayed after the selected branch video is displayed may be performed according to a predefined set of rules. The set of rules may consider the number of views and rating of videos in the video tree, the upload date, the identity of the user that updated the video file and the like.

Step 285 discloses update visual display of video tree after displaying video on video tree. When a user views a video, he may also view a visual display of the video tree, as shown in FIGS. 3A and 3B. In some cases, as the user views more and more videos of the video tree, and the system wishes to display the branch video currently displayed in the center of the video tree, different video files of the video tree are displayed in the visual display of the video tree. For example, when the branch video 360 of FIG. 3B is displayed, the system can display a video tree section having only the branch video 360 and its successor videos, instead of displaying the root video 301 and its successors, branch videos 310 and 350.

In some exemplary cases, the video regulating system automatically determines the route of video files of the video tree that are displayed to a user after the target video. The automatic determination may be performed in case the user reaches a video of the video that has successor videos, for example by pressing a link to the web page. When there are multiple options for displaying the next video, the video regulating system automatically determines the video files to be displayed to the user. The automatic determination of the video files may be performed according to a set of parameters, such as rating of video files, number of users that previously viewed the video file, identity of the user, identity of the user that added the video file to the video tree and the like. Step 290 discloses ending the video tree. The video tree unit 120 determines that the root video time has expired and no branch videos remain to be transmitted, the video unit tree 120 terminates the transmission.

While a video file is displayed at the viewer computer, the viewer may transmit a video selection to the video regulating system 125. The video regulating system 125 receives the viewer's selection as to a next video of the video tree to be displayed after the current video being displayed. The next video is selected from a plurality of video files of the video tree connected to the current video. The video selection may be performed by pointing on another video on the graphical representation of the video tree, the video tree is displayed on one portion of the display of the viewer computer next to the video file itself.

In some cases, the video regulating system 125 comprises a commercial content storage for storing commercial content in a video format. The commercial content may be added to the video tree as a commercial branch video. The viewer of videos of the video tree may transmit a video selection to review the commercial branch video of the video tree. In some exemplary cases, a specific commercial branch video is associated with video files of the video tree according to the content of the video files. For example, when the topic of the video tree is sports, the commercial branch video discloses a running shoe.

In some exemplary cases, the uploaded video file uploaded by a user of the video regulating system 125 is associated with the commercial branch video, such that the uploaded video file can only be displayed after the commercial branch video is displayed to the viewer. Users that upload a video file to be displayed after a commercial branch video may be rewarded using a shared revenue formula.

FIGS. 3A and 3B show visual displays of a video tree, according to exemplary embodiments of the subject matter. A root video 300 is the first video of the video tree to which other videos are linked as branch videos. The branch videos are uploaded by users as responses to other videos on the video tree. The branch videos may comprise multiple layers of branches, for example the root video 301 may be linked to two branch videos, B₁ 310 and B₂ 315. In some cases B₁ 310 and B₂ 315 are linked to the root video 301 at the same time marker. In such cases, the video unit tree 120 of FIG. 1 determines in which order the branch videos B₁ 310 and B₂ 315 are displayed. In other cases, the viewer requests the video B₁ 310 and receives both the root video 301 and the video B₁ 310. In some exemplary embodiments of the subject matter, the branch videos comprise links to additional branch videos. For example branch video B₂ 315 is a predecessor video to branch videos B₃ 320, B₄ 330, and B₅340.

FIG. 3B shows a frame shifted video tree in which the graphical representation of the video tree changes, according to exemplary embodiments of the subject matter. According to the example of FIG. 3B, when the video B₂^{R} 350 is displayed, visual of the video tree changes. The video B₂^{R} 350 may be linked to branch videos, such as branch videos B₃ 320, B₄ 330, and B₅340. In some cases, one of the branch videos, such as B₃ 320 may be linked to the branch video B₆360 which may be displayed to the viewer after B₃ 320 in the video tree. After the video tree has completed transmitting all of the videos the viewer may choose another video from the video tree to be viewed, or a video from a different video tree. In some exemplary cases, the viewer computer reviews the entire video tree.

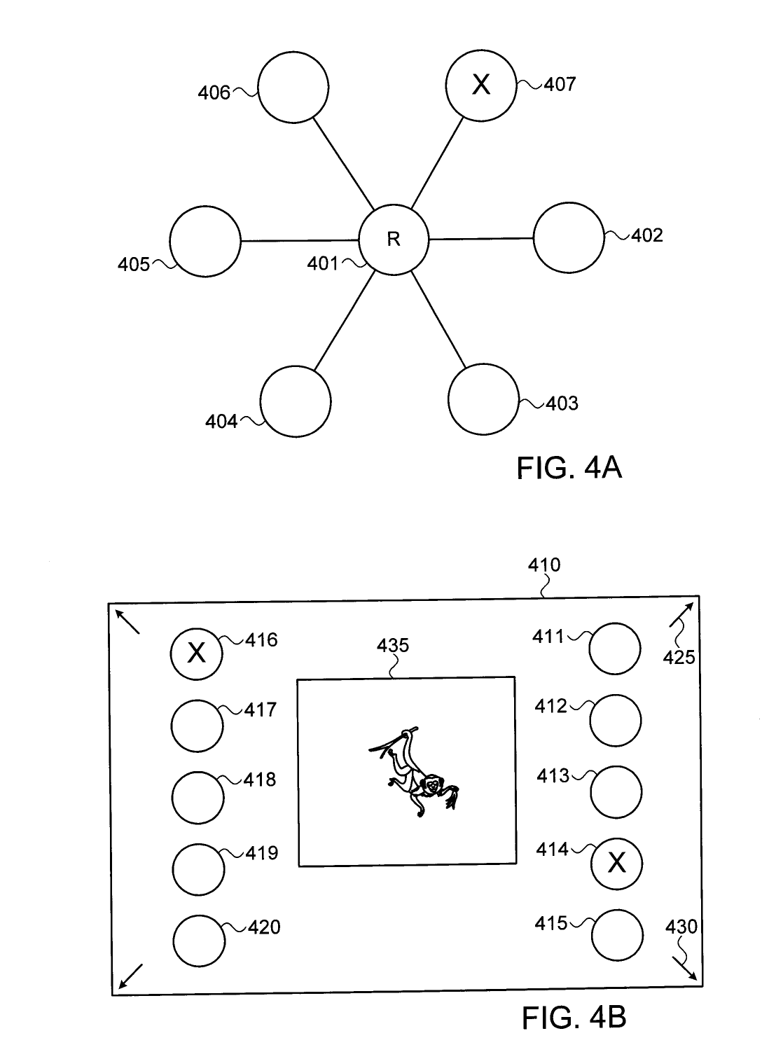

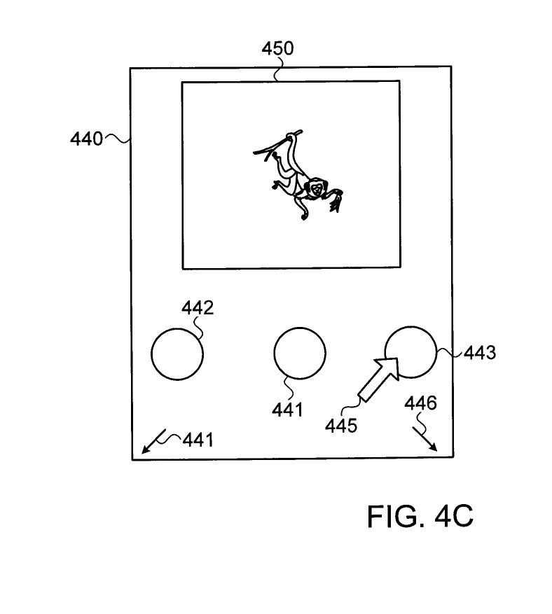

FIG. 4A shows a visual display of the video tree in the shape of a ring, according to exemplary embodiments of the subject matter. The video tree visual display comprises a root video 401 from which one or more branch videos extend, for example branch videos 402, 403, 404, 405, 406, and 408. In some exemplary embodiments one or more of the branch videos may be a commercial content branch video 407, which is automatically added into the video tree by the video regulation system 125 of FIG. 1. The commercial content branch video 407 may be displayed with a differentiating mark, such as an “X” to differentiate the commercial content branch video from the other branch videos

FIG. 4B shows a landscape display of a video tree, according to some exemplary embodiments of the subject matter. The video tree is displayed on a viewer computer display 410, where a video 435 is displayed in the center of the viewer computer display 410. One or more branch videos may be displayed on the left and right side of the viewer computer display 410 to allow the viewer to engage, select and view one of the branch videos while the video 435 is displayed. The plurality of videos may comprise of branch videos, such as 411, 412, 413, 415 on the right side of the viewer computer display 410, and branch videos, such as 417, 418, 419, and 420 on the left side of the viewer computer display 410. Commercial content branch videos may also comprise the videos available, such as commercial content videos 414 and 416. The viewer may scroll to additional branch videos that do not appear on the screen by using a top scroller 425, to scroll the branch videos in a clockwise manner, or by using a bottom scroller 430 to scroll the branch videos in a counter-clockwise manner. The branch videos may be scrolled in an animated manner, which shows them changing locations as the viewer scrolls through the videos.

FIG. 4C shows a portrait view of the video tree, according to some exemplary embodiments of the subject matter. The video tree is displayed on a viewer computer display 440, where a video 450 is displayed in the center of the viewer computer display 440. In some cases branch videos are available to be viewed by the viewer. The videos are located on the bottom of the screen, such as commercial videos 441, 442, and 443. The viewer may scroll to additional branch videos that do not appear on the screen by using a right-side scroller 446, to scroll the branch videos in a clockwise manner, or by using a left-side scroller 447 to scroll the branch videos in a counter-clockwise manner. The branch videos may be scrolled in an animated manner, which shows them changing locations as the viewer scrolls through the videos.

The viewer may use a controller icon 445 to interact with the scrollers and to scroll through the branch videos available. The controller icon may also be used by the viewer to choose one of the branch videos to be viewed. Once one of the branch videos is designated to display, the branch videos of the designated branch video replace the previously displayed branch videos on the bottom of the screen. In some cases, branch videos may also be displayed at the top of the screen for the viewer to display on the viewer computer display 440. In some exemplary embodiments of the subject matter, the viewer may switch between the landscape view of the video tree of FIG. 4B and the portrait view of FIG. 4C.

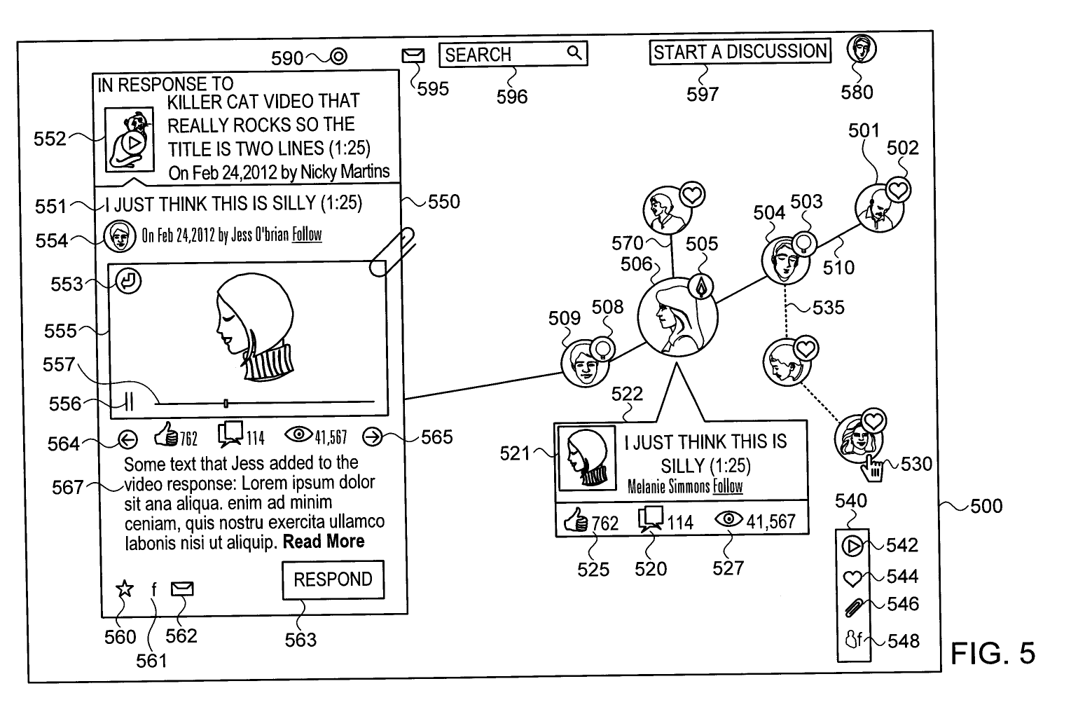

FIG. 5 shows a display of a video tree with a media player displaying a video, according to some exemplary embodiments of the subject matter. The display 500 shows a video tree with a branch video 504, which comprises additional branch videos attached by branches such as a highlighted branch 510. In some cases, a root video appears on the left of the screen and the as a viewer of the videos watches additional videos in the video tree the screen rolls to the right displaying additional branch videos. In this exemplary embodiment the root video is covered by a media player window 550. The highlighted branch 510 displays which branch videos are arranged for displaying. The root video 504 may comprise a picture or avatar of an uploader of the root video 504. The root video 504 may display an emotion, such as a light bulb icon 503. The root video 504 is connected to a branch video 501 that is associated with a heart icon 502. After the root video 504 is viewed, a branch video 506 may be displayed. The branch video 506 may be connected to a branch video 570, which is displayed with a thin line. The branch video 506 may comprise a fire icon 505 as an emotion. The branch video 506 may be displayed differently than the root video 504 in case the branch video 506 is currently displayed. The branch video 506 is connected to a branch video 508. In some cases, the branch video was uploaded as a response to the content of the branch video 506. The branch video 508 is displayed with a light bulb icon 509. The display 500 may display a detail window 522 which may show a user's details 521 such as an image, the name of a video, and a username. The user's details 521 may comprise a like icon 525 such as a thumbs up icon with a number of likes given to the video. The user's details 521 may comprise a comment icon 520 such as a text balloon icon with a number of likes given to the video, which may be expanded to show comments of other users. The comment icon 520 may further display additional comments that are connected to the comments of the video. The user's details 521 may comprise a view icon 527 such as an eye up icon, which displays a number of views of the video. The display 500 may comprise a pointer 530 which enables the user to select a different branch of the video tree. For example, the pointer 530 is placed on another branch 535, the another branch is highlighted, for example being a broken line, which changes to a bold line after the another branch 535 is selected.

The display may comprise the media player window 550, which shows a video from the video tree and which video is being displayed, whether it is the root video in the video tree or the branch video commenting on the root video. The media player window 550 may include a conversation topic display 552, which displays the topic of a conversation, which may be an image of a prior movie, iframe of an internet website, and the like. The media player window 550 displays a title of the video 551, a username image 554, an emotion 553, such as a fire icon. The media player window 550 shows a video display 555, which may comprise a play/pause icon 556 and a time marker 557. The media player window 550 displays may display a text box 567 relating to the video display 555. In some cases the media player window 550 displays a favorite icon 560, a peer network sharing icon 561, for example sharing the video on Facebook.com, and an invitation icon 562, to invite some user to view the video. The media player window 550 displays may comprise a respond icon 563 to enable the user viewing the video to comment on the video. The media player window 550 displays may comprise arrows 565 and 567 to enable the user to skip a previous branch video or a next branch video.

In some exemplary embodiments of the subject matter, the display 500 may comprise a notifications icon 590, which displays the number or replies to the video or to the user. The display 500 may comprise a letter icon 595, which informs the user of messages available for the user to see. The display 500 comprises of a search 596, which enables the user to search for video or video trees. The display 500 may comprise a discussion icon 597, which enables the user to start a new discussion that does not have to be related to a current video tree. In some cases, the display 500 comprises a user image 580, which shows an image of the user that does not have to be related to the video tree. In some cases, the display 500 comprises an interaction window 540, which may comprises icons such as a play icon 542, which enables the viewer to return to the root video and view the video tree from the beginning. The interaction window 540 may comprise an emotion icon 544, which enables the viewer to view the video tree with or without emoticons. The interaction window 540 may comprise a viewing icon 546, which enables the viewer to view the video tree with or without comments. The interaction window 540 may comprise a peer network icon 548, which enables the viewer to view which users commenting on the video tree may be connected to the viewer on a social network website, for example whether any of the users have a page on Facebook.com.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method, comprising:
obtaining a video tree, said video tree comprises two or more video files to be displayed on an online web page, one video file of said video tree is a video root;
receiving an uploaded video file at the online web page, said uploaded video file is uploaded by a user of the web page in response to another video of the video tree;
receiving a video tree selection from the user, said video tree selection comprises a location of the uploaded video file in the video root;
adding the uploaded video file to the video root according to the received video tree selection;
displaying the uploaded video file on the online web page according to the video tree selection; wherein the uploaded video file is displayed after predecessor videos on the video tree.

2. The method of claim 1, further comprising a step of designating a time marker on at least one of the predecessor videos for displaying the uploaded video file after the time marker.

3. The method of claim 2, further comprising a step of displaying the uploaded video file according to the designated time marker.

4. The method of claim 2, wherein the time marker indicates a time in the middle of another video on the video tree.

5. The method of claim 1, wherein the video tree selection comprises a reference to a predecessor video to which the uploaded video responds.

6. The method of claim 1, wherein the root video is the first video of the video tree.

7. The method of claim 1, wherein the uploaded video is linked to the root video.

8. The method of claim 1, wherein the branch video is linked to another branch video of the video tree.

9. The method of claim 1, wherein uploading the video file does not interfere with the order of display of other video files of the video tree.

10. The method of claim 1, further comprises graphically displaying the video tree of the videos and having the displayed video as the video root of the displayed video tree.

11. The method of claim 10, further comprises updating the graphically displayed video tree upon displaying a new video of the video tree.

12. The method of claim 1, further comprises receiving a viewer's selection as to a next video of the video tree to be displayed after a current video of the video tree being displayed.

13. The method of claim 12, wherein the next video is selected from a plurality of video files of the video tree connected to the current video, the plurality of video files are graphically represented as a video tree to the user on a first display section on a display device while the current video is displayed on a second section on the display device.

14. The method of claim 12, further comprises graphically displaying a route of videos on the video tree to the uploaded video.
